(19) United States
(12) Patent Application Publication
(10) Pub. No.: US 2011/0247592 A1
(43) Pub. Date: Oct. 13, 2011

(54) CANISTER WITH HEATER

(75) Inventors: Hyun KI Kim, Pyeongtaek-si (KR); Tae Kyu Hwang, Pyeongtaek-si (KR); Joon Young Choi, Ansung-si (KR); Yu Min Kim, Ansung-si (KR)

(73) Assignee: KOREA FUEL-TECH CORPORATION, Ansung-si (KR)

(21) Appl. No.: 13/085,479

(22) Filed: Apr. 13, 2011

(30) Foreign Application Priority Data
Sep. 25, 2009 (KR) 10-2009-0091104

(51) Int. Cl. F02M 33/06

(52) U.S. Cl. 123/519

(57) ABSTRACT

Disclosed herein is a canister mounted in a vehicle to reduce the discharge of fuel gas. The canister of the present invention includes at least one pocket installed in a canister housing. The pocket divides the inner space of the canister housing into first and second spaces. A heater is inserted into the pocket from the outside of the canister housing. The heater generates heat during running of an engine to heat active carbon filled in the canister. When the active carbon is heated, fuel gas adsorbed onto the active carbon in a liquid phase is easily evaporated and supplied to the engine. The heater can significantly improve desorption efficiency of the fuel gas by the active carbon.

### CROSS-REFERENCE TO RELATED APPLICATION

This application claims the benefit of Korean Patent Application No. 10-2009-0091104, filed on Sep. 25, 2009, the entire disclosure of which is hereby incorporated by reference.

### BACKGOUND OF THE INVENTION

1. Field of the Invention

The present invention relates to a canister mounted in a vehicle to reduce the discharge of fuel gas and, more particularly, to a canister with a heater configured such that fuel gas adsorbed onto active carbon filled in the canister is more easily desorbed from the active carbon and introduced into an engine.

2. Description of Related Art

Typically, an apparatus for storing fuel gas generated from a fuel tank and transferring it to an engine is employed in a vehicle, and such an apparatus is generally referred to a canister.

Fuel required for driving the engine is stored in the fuel tank. When the fuel is evaporated in the fuel tank by environmental factors such as ambient temperature and the like, the fuel gas is generated. The fuel gas contains harmful components such as hydrocarbon (HO) and the like, and thus, if the fuel gas is discharged to the outside of the vehicle, the air is polluted and the fuel is wasted.

The canister adsorbs and stores the fuel gas generated from the fuel tank when the engine stops using active carbon filled in the canister and retransfers the stored fuel gas to the engine when the engine is running, thereby preventing the air pollution and the loss of fuel. Korean Patent Publication Nos. 2004-0090740, 2004-0017053, and 2003-0089139 disclose these types of canisters.

FIG. 1 is a schematic diagram showing the connection of a canister 1 and a fuel tank 2.

As shown in FIG. 1, an inlet pipe 3 of the canister 1 is connected to the fuel tank 2. When the vehicle engine is turned off, the fuel gas generated from the fuel tank 2 is introduced to the canister 1 through the inlet pipe 3 by the internal pressure of the fuel tank 2.

Active carbon is filled in the canister 1 to adsorb the fuel gas. The fuel gas introduced through the inlet pipe 3 is adsorbed onto the active carbon in the canister 1. Of course, in this case, the remaining fuel gas, which is not adsorbed onto the active carbon, is discharged to the air through an outlet pipe 4 connected to the canister 1.

Moreover, the canister 1 is connected to a throttle tube 6 through a guide pipe 5, and the guide pipe 5 includes a control valve 7 for preventing the fuel gas from being introduced from the canister 1 to the throttle tube 6. The control valve 7 is closed when the engine is stopped, while it is opened the engine is running.

When a driver starts the vehicle to run the engine, the air is supplied to the engine through the throttle tube 6. In this state, the internal pressure of the throttle tube 6 is lower than the atmospheric pressure, and thus the outside air is introduced into the throttle tube 6 through the outlet pipe 4, the canister 1, and the guide pipe 5. At this time, the fuel gas adsorbed onto the active carbon in the canister 1 is desorbed and supplied to the engine along with the introduced air through the throttle tube 6.

The active carbon provided in the canister 1 has the following characteristics.

Fuel gas in a gas phase is liquefied by the active carbon and adsorbed onto the active carbon. Heat generated when the fuel gas is changed to a liquid phase is dissipated to the outside of the canister.

When the fuel gas adsorbed onto the active carbon in a liquid phase is introduced into the engine by the flow of the outside air, the fuel gas in a liquid phase is evaporated and introduced into the engine in a gas phase. In this case, the active carbon absorbs the heat around the canister to convert the fuel gas to a gas phase.

Meanwhile, the use of hybrid vehicles driven by both an internal combustion engine and an electric motor has been gradually increased to meet the demands for improvement of fuel efficiency of gasoline vehicles and for development of environmentally-friendly vehicles.

Such hybrid vehicles are configured such that gasoline fuel is used to drive the engine and electricity is used to provide driving force, and thus the desorption amount of the fuel gas adsorbed onto the canister is reduced. That is, the engine does not require air when the electricity is used to drive the engine, and thus the amount of fuel gas adsorbed onto the canister is increased proportionately.

However, the heat supplied to the canister is reduced by the operation of the engine and the like, and thus the amount of the fuel gas desorbed from the active carbon in the canister is reduced.

In order to solve the above problem, it is necessary to install high-performance active carbon and large-capacity canister in the vehicle such that a larger amount of fuel gas adsorbed onto the active carbon can be evaporated and supplied to the engine for a shorter period of time.

U.S. Pat. No. 6,896,852, U.S. Pat. No. 6,769,415, and Korean Patent Publication No. 10-2007-0049425 disclose canisters for solving the above-described problem.

U.S. Pat. No. 6,896,852 discloses a canister, in which a heater is installed to heat air introduced through an outlet pipe of the canister. The heater heats the air supplied to the canister. The heated air supplies the heat required for the desorption reaction of the canister such that the fuel gas adsorbed onto the active carbon is more easily desorbed.

However, the above-described canister has a problem in that the temperature of the air heated by the heater is not greater than 100° C. and the actual temperature of the air supplied to the active carbon is maintained at about 80° C.

Moreover, the heat of the air heated and supplied to the active carbon is absorbed by the active carbon around an inlet port thereof such that the heat is not uniformly distributed to the entire active carbon. As a result, the desorption efficiency of the canister by the heated air is insignificant, which just meets the partial zero emission vehicle (PZEV) standards for exhaust emissions.

U.S. Pat. No. 6,769,415 discloses a canister in which a heating coil is installed in active carbon being in contact with an outlet pipe of the canister to directly heat the active carbon.

However, since the heat is supplied only to the active carbon being in contact with the outlet pipe, the heat is absorbed by the corresponding active carbon, and thereby the heat is not supplied to the entire active carbon. As a result, the desorption efficiency of the canister is insignificant, which just meets the partial zero emission vehicle (PZEV) standards for exhaust emissions.

Meanwhile, Korean Patent Publication No. 10-2007-0049425 discloses a vehicle canister, in which a chamber is provided in a canister housing and a heat storage material such as sodium thiosulfate or sodium phosphate is filled in the chamber to store heat generated by adsorption reaction and supply the stored heat to active carbon during desorption reaction, thus improving adsorption and desorption efficiency of the active carbon.

However, the temperature of the heat generated by the heat storage material filled in the chamber during desorption reaction is lower than a predetermined temperature, and thus the canister does not satisfy the desorption rate required by the hybrid vehicle.

### SUMMARY OF THE INVENTION

The present invention has been made in an effort to solve the above-described problems associated with prior art, and an object of the present invention is to provide a canister with a heater which can supply heat, required for desorption of fuel gas adsorbed onto active carbon filled in the canister, to the entire active carbon, thus improving the desorption efficiency of the active carbon.

In a first aspect, the present invention provides a canister connected to a fuel tank and a throttle tube and adsorbing and desorbing fuel gas generated in the fuel tank, the canister including: a canister housing including a tank port, a purge port, and an air port, which are provided at the top thereof, and a pocket for dividing the canister housing into a first space and a second space with respect to the tank port or the purge port and the air port; active carbon filled in the first and second spaces of the canister housing; and a heater inserted into the pocket of the canister housing and supplying heat to the active carbon filled in the canister housing, wherein the pocket has one open side such that the heater is inserted from the outside of the canister housing to the pocket.

In a second aspect, the present invention provides a canister connected to a fuel tank and a throttle tube and adsorbing and desorbing fuel gas generated in the fuel tank, the canister including: a canister housing including a tank port, a purge port, and an air port, which are provided at the top thereof, and a plurality of pockets each accommodating a heater from the outside of the canister housing; active carbon filled in the canister housing; and a plurality of heaters inserted into the pockets of the canister housing and supplying heat to the active carbon filled in the canister housing.

The heater may be a positive temperature coefficient (PTC) heater.

The active carbon filled in the first and second spaces may absorb heat generated from the heater inserted into the pocket.

The active carbon filled in the canister housing may adsorb heat generated from the plurality of heaters inserted into the pockets on the outside of the canister housing.

The canister may further include a coil heater connected to the air port and heating air introduced into the canister.

### BRIEF DESCRIPTION OF THE DRAWINGS

The above and other features of the present invention will be described with reference to certain exemplary embodiments thereof illustrated the attached drawings in which:

FIG. 1 is a schematic diagram showing the connection between a conventional canister and a fuel tank.

FIG. 2 is a perspective view of a canister with a heater according to a preferred embodiment of the present invention.

FIG. 3 is an exploded perspective view of the canister of FIG. 2.

FIG. 4 is a front cross-sectional view of the canister of FIG. 2.

FIG. 5 is schematic diagram showing the connection between a canister according to the present invention and a fuel tank.

FIG. 6 is a front cross-sectional view of a canister with a plurality of heaters according to another preferred embodiment of the present invention.

FIG. 7 is a front cross-sectional view of a canister with a heater according to still another preferred embodiment of the present invention.

### DETAILED DESCRIPTION OF THE INVENTION

Hereinafter, preferred embodiments in accordance with the present invention will be described with reference to the accompanying drawings. The preferred embodiments are provided so that those skilled in the art can sufficiently understand the present invention, but can be modified in various forms and the scope of the present invention is not limited to the preferred embodiments.

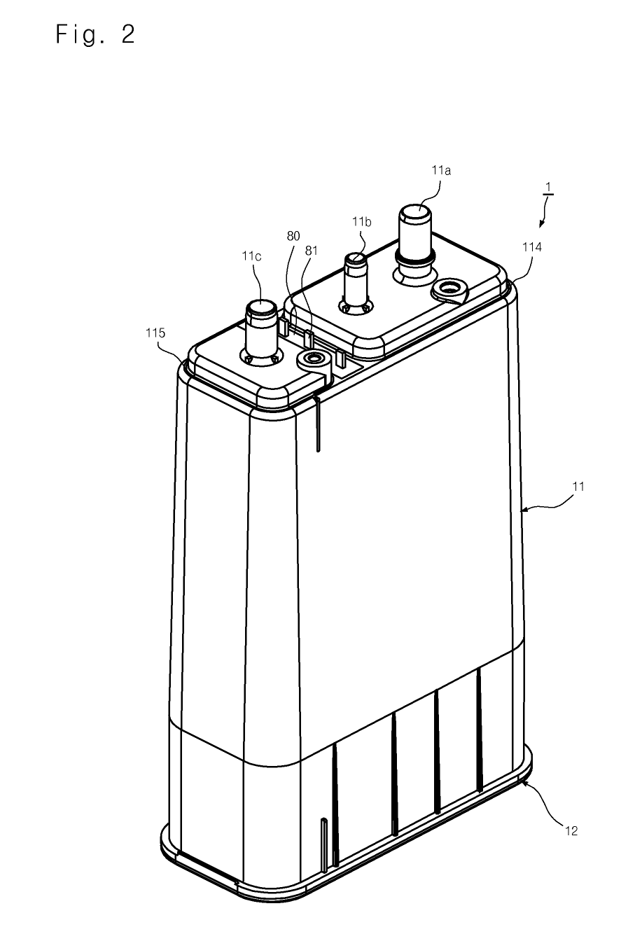

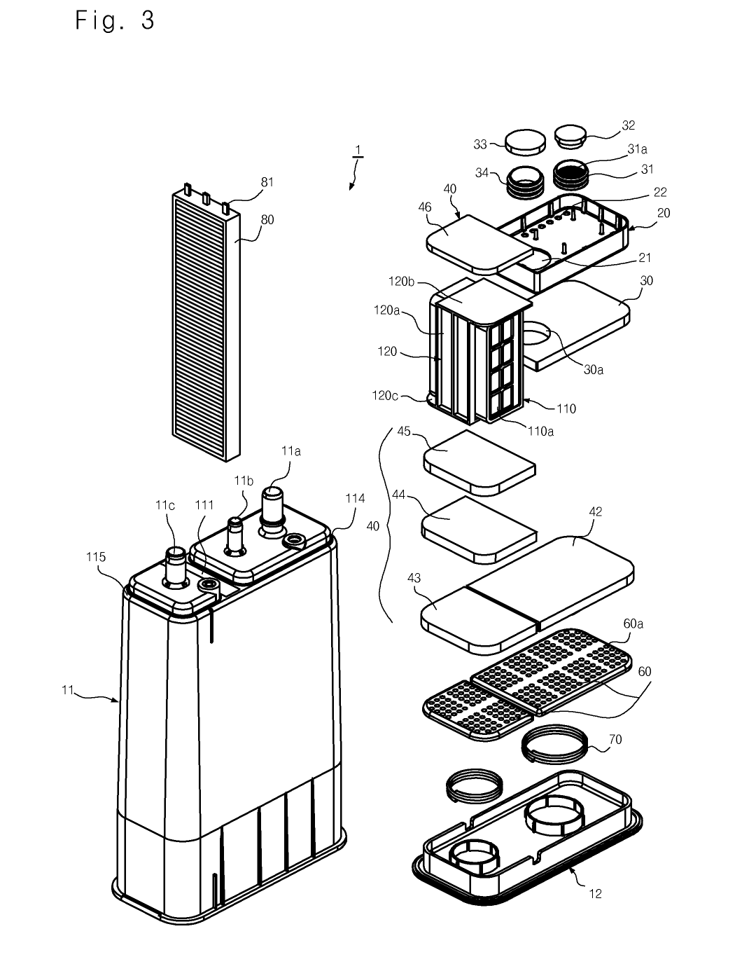

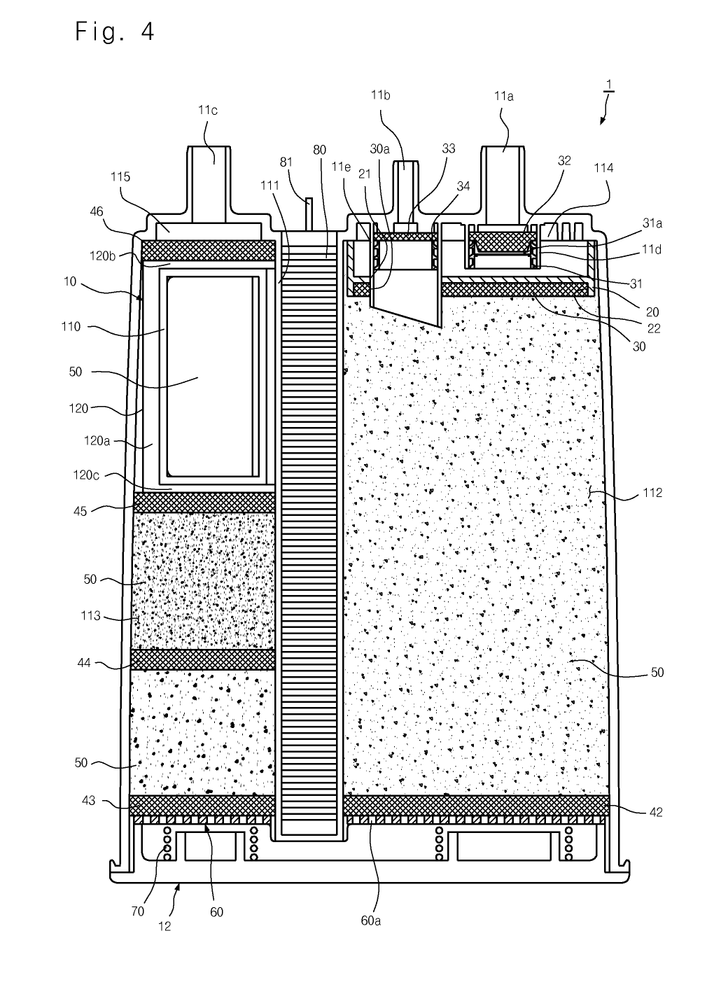

FIG. 2 is a perspective view of a canister with a heater according to a preferred embodiment of the present invention, FIG. 3 is an exploded perspective view of the canister of FIG. 2, and FIG. 4 is a front cross-sectional view of the canister of FIG. 2.

The canister 1 includes a canister housing 11 and a lower plate 12 connected to the bottom of the canister housing 11. A fuel gas reducing device 10, a diffusion trap 20, a coating filter 30, a support filter 40, active carbon 50, a strainer 60, and an elastic member 70 are provided in the canister housing 11.

A pocket 111 is provided in the center of the canister housing 11 along the longitudinal direction thereof. The pocket 111 has a rectangular shape with an open top, and a heater 80 is detachably inserted into the pocket 111. The heater 80 is to supply heat to the active carbon 50 filled in the canister housing 11, which will be described later.

The canister housing 11 has a trapezoidal shape with an open bottom in which the width is reduced from the bottom to the top. The inner space of the canister housing 11 is vertically divided into two spaces by the pocket 111 such as a first space 112 and a second space 113. The active carbon 50 is filled in the first and second spaces 112 and 113, which will be described later.

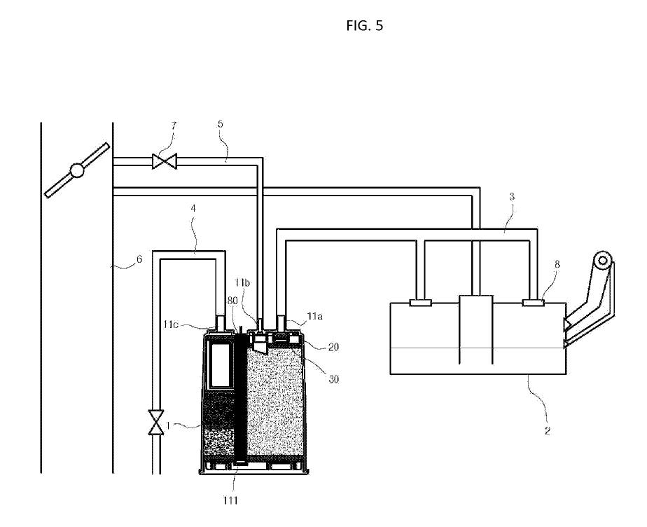

A tank port 11a, through which fuel gas generated from a fuel tank 2 (shown in FIG. 5) is introduced, and a purge port 11b, through which the fuel gas is discharged to a guide pipe 5 (also shown in FIG. 5), are provided at the top of the first space 112. An air port 11c for introducing and discharging air is provided in the center of the top of the second space 113.

A mesh ring connection portion 11d is provided at the bottom of the tank port 11a, and a fixing ring connection portion 11e is provided at the bottom of the purge port 11b.

A sponge 32 is inserted and connected to the mesh ring connection portion 11d and a mesh ring 31 is placed at the bottom of the sponge 32 such that the sponge 32 and the mesh ring 31 are fixed to the mesh ring connection portion 11d. A mesh 31a is provided in the middle of the mesh ring 31. The mesh 31a is to prevent the active carbon 50 from leaking through the tank port 11a when the canister 1 is damaged.

A purge filter 33 is inserted and connected to the fixing ring connection portion 11e and a filter fixing ring 34 for fixing the purge filter 33 is connected thereto. The purge filter 33 is fixed to the fixing ring connection portion 11e by the filter fixing ring 34.

The active carbon 50 filled in the canister is prevented from leaking through the tank port 11a and the purge port 11b, when the canister 1 is damaged, by the sponge 32 and the mesh ring 31 provided in the mesh ring connection portion 11d and by the purge filter 33 and the filter fixing ring 34 provided in the fixing ring connection portion 11e.

An air gap 114 is formed at the top of the first space 112, and the diffusion trap 20 is provided at the bottom of the air gap 114. The air gap 114 and the diffusion trap 20 allow the fuel gas introduced through the tank port 11a to pass through the active carbon 50 over a wider range.

The diffusion trap 20 has a rectangular shape with an open top and includes a plurality of holes formed on the bottom surface thereof. A connecting hole 21, through which the fixing ring connection portion 11e is connected, is formed on the bottom surface corresponding to the purge port 11b, and a plurality of fixing holes 22 are provided on the bottom surface to mount the coating filter 30.

The diffusion trap 20 is integrally connected to the air gap 114 by ultrasonic welding to prevent the active carbon 50 from leaking through the tank port 11a and the purge port 11b when the canister 1 is damaged.

A hole 30a is formed on one side of the coating filter 30, and the fixing ring connection portion 11e is inserted and connected to the hole 30a. The coating filter 30 is integrally connected to the bottom of the diffusion trap 20 by ultrasonic welding. Active carbon is coated on the coating filter 30 to prevent active carbon powder from leaking. The coating filter 30 is to prevent the active carbon 50 filled in the first space 112 from leaking to the outside.

A first support filter 42 is provided at the bottom of the first space 112, and the active carbon 50 is filled between the coating filter 30 and the first support filter 42. As the active carbon 50, 13GRADE is used, for example. The first support filter 42 is to prevent the active carbon 50 filled in the first space 112 from leaking to the outside.

A second support filter 43 is provided at the bottom of the second space 113 to prevent the active carbon 50 from leaking to the outside. The strainer 60 is provided at the bottom of the first and second support filters 42 and 43 to entirely support the active carbon 50 filed in the first and second spaces 112 and 113. The strainer 60 is elastically supported to the lower plate 12 by the elastic member 70.

The second space 113 is divided into a plurality of spaces by the second to fifth support filters 43 to 46. 13GRADE, for example, as the active carbon 50 is filled between the second and third support filters 43 and 44, and 11GRADE, for example, as the active carbon 50 is filled between the third and fourth support filters 44 and 45. The fuel gas reducing device 10 is interposed between the fourth and fifth support filters 45 and 46.

The fifth support filter 46 is spaced a predetermined distance from the air port 11c by the air gap 115 formed at the top of the second space 113 such that the air is easily introduced and discharged through the air port 11c.

The fuel gas reducing device 10 includes a fuel gas reducing block 110 and a bracket 120 for accommodating the fuel gas reducing block 110.

The fuel gas reducing block 110 includes windows 110a formed on both sides to allow the fuel gas to pass through the fuel gas reducing block 110. The windows 11a are installed in a direction perpendicular to the flow direction of the fuel gas, which is introduced through the tank port 11a and discharged to the air port 11c, in the canister housing 11. 5-9GRADE, for example, as the active carbon 50 is filled in the furl gas reducing block 110.

The fuel gas discharged through the fourth support filter 45 flows through the space between the fuel gas reducing block 110 and one inner wall of the canister housing 11 and is introduced to the fuel gas reducing block 110 through one window 110a of the fuel gas reducing block 110. The fuel gas discharged through the other window 110a of the fuel gas reducing block 110 flows to the top through the space between the fuel gas reducing block 110 and the other inner wall of the canister housing 11 and is discharged through the air port 11c.

The outside air introduced through the air port 11c passes through the fifth support filter 46, flows through the space between the fuel gas reducing block 110 and the other inner wall of the canister housing 11, and is introduced into the fuel gas reducing block 110 through the other window 110a of the fuel gas reducing block 110. The air discharged through one window 110a of the fuel gas reducing block 110 moves to the bottom through the space between the fuel gas reducing block 110 and one inner wall of the canister housing 11 and flows through the fourth support filter 45.

As mentioned above, the pocket 111 is interposed between the first space 112 and the second space 113 along the longitudinal direction. The heater 80 is detachably inserted into the pocket 111. The heater 80 may be a positive temperature coefficient (PTC) heater. Of course, the type of the heater 80 is not particularly limited, but any heater with high thermal efficiency may be used.

The heater 80 is electrically operated, and thus power terminals 81 for receiving external power are provided at the top of the heater 80. The power terminals 81 are electrically connected to a power supply means such as a generator motor of the vehicle, for example. Electric power is supplied to the power terminals 81 when the engine of the vehicle is running to allow the heater 80 to be operated. Especially, the heater 80 includes a heat radiation plate provided on both surfaces facing the first and second spaces 112 and 113 to uniformly supply the heat to the first and second spaces 112 and 113.

Next, the operation of the canister having the above-described configuration will be described with reference to FIG. 5, which shows the connection between the canister and the fuel tank.

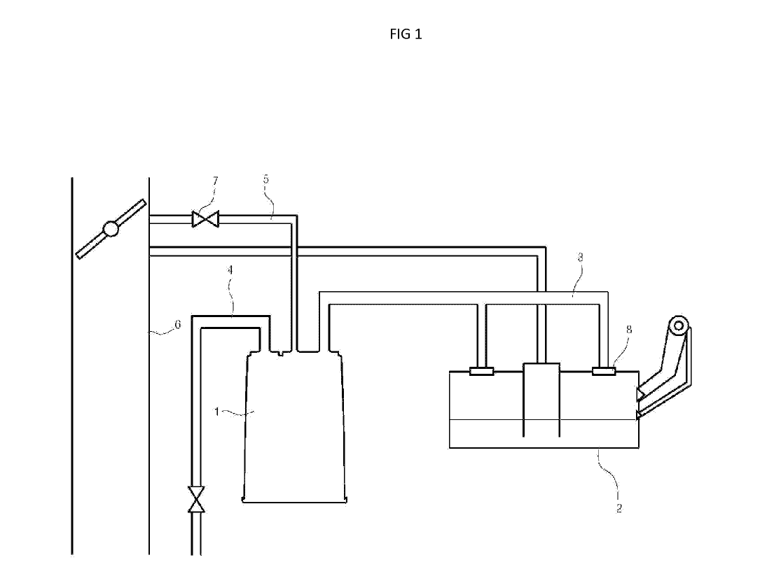

As described with reference to FIG. 1, when the liquid fuel stored in the fuel tank 2 is evaporated by the high temperature while the engine is stopped, the pneumatic pressure in the fuel tank 2 is increased by the evaporated fuel gas. The evaporated fuel gas is introduced into the tank port 11a of the canister 1 through the inlet pipe 3 connected to the fuel tank 2 by the pneumatic pressure.

The fuel gas introduced into the tank port 11a moves to the bottom through the first space 112 of the canister 1, flows into the second space 113 through the inner space between the first support filter 42 and the lower plate 12 and through the second support filter 43, and reaches the fuel gas reducing device 10.

At this time, the fuel gas is liquefied by the active carbon 50 filled in the canister 1 and adsorbed onto the active carbon 50, and the remaining fuel gas moves to the fuel gas reducing device 10. Then, the fuel gas passes through the fuel gas reducing device 10 and is discharged to the outside through the air port 11c.

Subsequently, when a driver starts the vehicle to run the engine, the pneumatic pressure of the throttle tube 6 is reduced and the control valve 7 is opened. Accordingly, the outside air is introduced into the canister 1 through the outlet pipe 4 and the air port 11c, flows through the canister 1 in a direction opposite to the flow direction of the fuel gas, is introduced into the throttle tube 6 through the purge port 11b and the guide pipe 5, and then supplied to the engine as described with reference to FIG. 1.

Meanwhile, when the engine of the vehicle is running, electric power is supplied to the heater 80 provided in the canister 1. Then, the heater 80 is heated to about 150° C., and the heat generated from the heater 80 is transferred to the active carbon 50 filled in the first and second spaces 112 and 113 of the canister 1.

The heat supplied to the active carbon 50 is uniformly transferred to the inside of the canister 1 through the active carbon 50 and absorbed by the active carbon 50, and thereby the temperature of the entire active carbon 50 is increased. Then, the fuel gas adsorbed onto the active carbon 50 is easily evaporated. The evaporated fuel gas in the canister 1 moves through the air port 11c along with the introduced air and is discharged through the purge port 11b.

That is, in this embodiment, when the engine of the vehicle is running, the heater 80 is operated to heat the entire active carbon 50 filled in the canister 1, and thereby the fuel gas adsorbed onto the active carbon 50 in a liquid phase is easily evaporated. Therefore, most fuel gas adsorbed onto the active carbon 50 is evaporated and discharged through the purge port 11b.

Meanwhile, in this embodiment, a single heater 80 is installed in the center of the canister 1 along the longitudinal direction. However, the installation space of the heater and its number are not particularly limited.

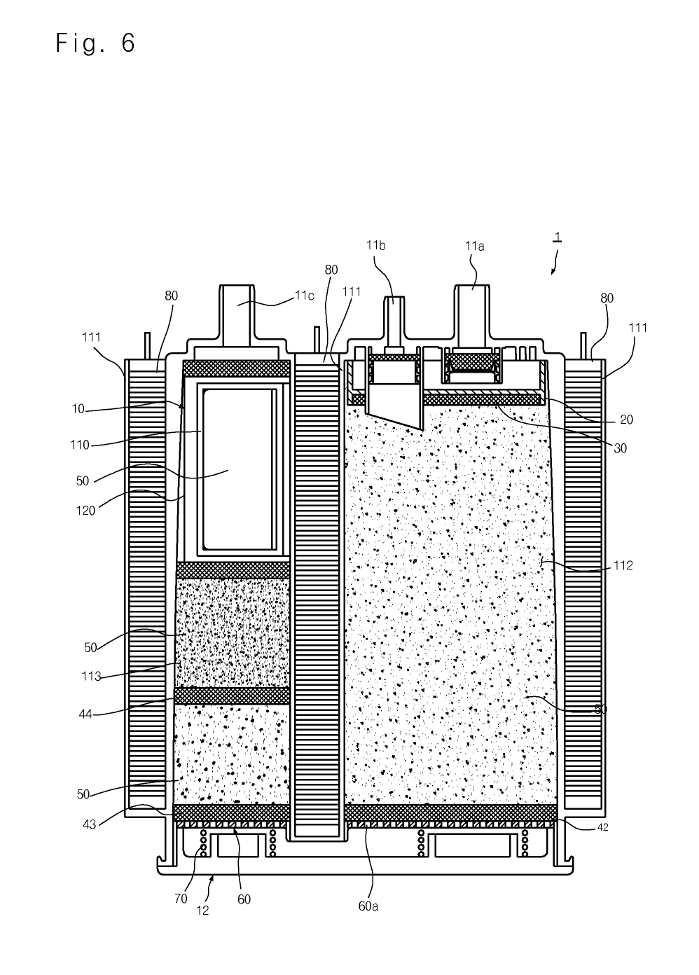

FIG. 6 is a front cross-sectional view of a canister with a plurality of heaters according to another preferred embodiment of the present invention.

In this embodiment, a plurality of pockets 111 each accommodating a heater 80 is provided in the center of the canister 1 and on both sides thereof. A plurality of heaters 80 are detachably inserted into the pockets 111.

In this embodiment, heat is supplied from both sides of the first and second spaces 112 and 113 of the canister 1 thereto. Therefore, it is possible to uniformly supply heat to the entire active carbon 50 filled in the canister 1 such that the fuel gas adsorbed onto the active carbon 50 is more efficiently supplied to the engine.

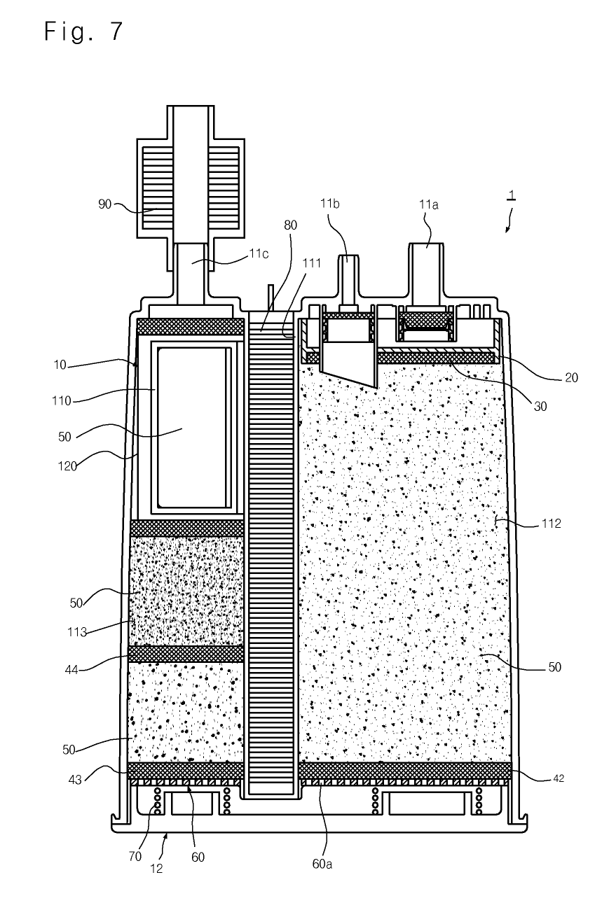

Moreover, FIG. 7 is a front cross-sectional view of a canister with a heater according to still another preferred embodiment of the present invention.

In this embodiment, a pocket 111 and a heater 80 are provided in the center of the canister 1 in the same manner as the preferred embodiment of the present invention, and a coil heater 90 is further provided on the outside of the air port 11c through which the outside air is introduced into the canister 1.

The coil heater 90 is to heat the air introduced through the air port 11c and is operated together with the heater 80 inserted into the pocket 111. The coil heater 90 receives electric power along with the heater 80 during running of the engine and is heated to about 150° C. When the coil heater 90 is operated, the air introduced through the air port 11c is heated to about 80° C.

In this embodiment, since the active carbon 50 filled in the canister 1 is heated and, at the same time, the air supplied to the canister 1 is heated, it is possible to further improve the desorption efficiency of the fuel gas by the canister 1.

As above, preferred embodiments of the present invention have been described and illustrated, however, the present invention is not limited thereto, rather, it should be understood that various modifications and variations of the present invention can be made thereto by those skilled in the art without departing from the spirit and the technical scope of the present invention as defined by the appended claims.

For example, the configuration shown in FIG. 7 can be applied to the embodiment shown in FIG. 6. That is, it is possible to install the coil heater 90 on the outside of the air port 11c of the canister 1 in the embodiment shown in FIG. 6 to heat the air introduced through the air port 11c.

As described above, according to the canister of the present invention, in which the pocket for dividing the canister housing into the first and second spaces and accommodating the heater is provided such that the heat, generated by the heater when the vehicle engine is running, is supplied to the entire active carbon filled in the first and second spaces of the canister housing.

As a result, the temperature of the active carbon is increased when the vehicle engine is running, thus significantly improving the desorption rate of the fuel gas adsorbed onto the active carbon.

What is claimed is:

1. A canister connected to a fuel tank and a throttle tube and adsorbing and desorbing fuel gas generated in the fuel tank, the canister comprising:
a canister housing including a tank port, a purge port, and an air port, which are provided at the top thereof, and a pocket for dividing the canister housing into a first space and a second space with respect to the tank port or the purge port and the air port;
active carbon filled in the first and second spaces of the canister housing; and
a heater inserted into the pocket of the canister housing and supplying heat to the active carbon filled in the canister housing,
wherein the pocket has one open side such that the heater is inserted from the outside of the canister housing to the pocket.

2. The canister of claim 1, wherein the heater is a positive temperature coefficient (PTC) heater.

3. The canister of claim 1, wherein the active carbon filled in the first and second spaces absorbs heat generated from the heater inserted into the pocket.

4. The canister of claim 1, further comprising a coil heater connected to the air port and heating air introduced into the canister.

5. A canister connected to a fuel tank and a throttle tube and adsorbing and desorbing fuel gas generated in the fuel tank, the canister comprising:
a canister housing including a tank port, a purge port, and an air port, which are provided at the top thereof, and a plurality of pockets each accommodating a heater from the outside of the canister housing;
active carbon filled in the canister housing; and
a plurality of heaters inserted into the pockets of the canister housing and supplying heat to the active carbon filled in the canister housing.

6. The canister of claim 5, wherein each of the heaters is a positive temperature coefficient (PTC) heater.

7. The canister of claim 5, wherein the active carbon filled in the canister housing adsorbs heat generated from the plurality of heaters inserted into the pockets on the outside of the canister housing.

8. The canister of claim 5, further comprising a coil heater connected to the air port and heating air introduced into the canister.
